(19) United States
(12) Patent Application Publication
(10) Pub. No.: US 2025/0341736 A1
(43) Pub. Date: Nov. 6, 2025

(54) Functional Jewelry System

(71) Applicant: Raley Blackburn, Canyon, TX (US)

(72) Inventor: Raley Blackburn, Canyon, TX (US)

(21) Appl. No.: 19/199,332

(22) Filed: May 5, 2025

Related U.S. Application Data
(60) Provisional application No. 63/642,828, filed on May 5, 2024.

(51) Int. Cl. G02C 11/02; A44C 5/20; A44C 11/00; A44C 13/00; A44C 25/00; G02C 3/00

(52) U.S. Cl. CPC G02C 11/02; A44C 5/2014; A44C 5/2019; A44C 11/00; A44C 13/00; A44C 25/001; A44C 25/008; G02C 3/006; A44D 2203/00

(57) ABSTRACT

A functional jewelry system may be presented as armless sunglasses/glasses when they are on a user's face. The functional jewelry system may include chains or other connecting portions extending from each side of the sunglasses/glasses behind, over, and/or around each of the user's ears. The chains/connecting portions may position the sunglasses/glasses on the user's face so that they may stay in place. The chain/connecting portions may be adorned with decorative items. When the user no longer wishes to wear the sunglasses/glasses, they may be removed from the user's face, and end portions of each side of the chain or other connecting portion may be connected to one another through a fastening or attachment mechanism, including, but not limited to, clasps, hooks, loops, and/or magnet closures.

### CROSS-REFERENCE TO RELATED APPLICATION

The present Application is a non-provisional of, and claims priority to, U.S. Patent Application No. 63/642,828 filed May 5, 2025, the disclosure of which is incorporated by reference in its entirety.

### FIELD OF THE DISCLOSURE

The present disclosure generally relates to functional jewelry systems, and more particularly systems for transforming sunglasses/glasses into functional jewelry.

### BACKGROUND

Unhinged or armless sunglasses/glasses may be desirable as they may be less likely to break, for example, from a child pulling on them. However, it can be challenging to figure out what to do with the sunglasses/glasses when the user is not wearing them.

### SUMMARY

Embodiments of the present disclosure may provide functional jewelry systems wherein unhinged sunglasses/glasses may be transformed into functional jewelry through use of one or more attachment mechanisms including, but not limited to, clasps, hooks, loops, and/or magnet closures. In an embodiment of the present disclosure, unhinged sunglasses/glasses may be worn as a necklace when the sunglasses/glasses are not in use.

Some embodiments of the present disclosure may provide a functional jewelry system configured to function with a pair of sunglasses or glasses, the functional jewelry system comprising: a connecting portion that extends from each side of the pair of sunglasses or glasses, the connecting portion having end portions, wherein the connecting portion may position the pair of sunglasses or glasses on a user's face when the sunglasses or glasses are in use and when the sunglasses or glasses are not in use, the end portions may be connected to one another through an attachment mechanism with the sunglasses or glasses forming part of a necklace with the connecting portion; and one or more decorative items on the connecting portion. The connecting portion may be a chain. The connecting portion may extend behind, over, and/or around each of a user's ears. The attachment mechanism may be selected from one or more of the following: clasps, hooks, loops, and/or magnet closures. The part of the necklace formed by the sunglasses or glasses may be positionable so that the sunglasses or glasses are not visible as part of the necklace. The part of the necklace formed by the sunglasses or glasses may be capable of laying on or around a user's chest portion. The one or more decorative items may be stones and feathers. Only one decorative item may extend from the connecting portion. The connecting portion may comprise chains extending from each side of the sunglasses or glasses and the chains attached to one another through a ribbon or bow. The ribbon or bow may be formed of a cloth material. The connecting portion may comprise chains extending from each side of the sunglasses or glasses and the chains attached to one another through a decorative item. The decorative item may be a pendant. The one or more decorative items may be clasped to the connecting portion. The one or more decorative items may be attachable to one another. The connecting portion may have one or more holes or openings along a length of the connecting portion to receive the attachment mechanism. The functional jewelry system may be a unitary system. The one or more decorative items, the pair of sunglasses or glasses, and the connecting portion may be separate items.

Other embodiments of the present disclosure may provide a functional jewelry system configured to function with a pair of sunglasses or glasses, the functional jewelry system comprising: a connecting portion that extends from each side of the pair of sunglasses or glasses, the connecting portion having end portions, wherein the connecting portion may position the pair of sunglasses or glasses on a user's face when the sunglasses or glasses are in use and when the sunglasses or glasses are not in use, the end portions may be connected to one another through an attachment mechanism with the sunglasses or glasses forming part of a jewelry item with the connecting portion; and one or more decorative items on the connecting portion.

Further embodiments of the present disclosure may provide a functional jewelry system configured to function with a pair of sunglasses or glasses, the functional jewelry system comprising: a connecting portion that extends from each side of the pair of sunglasses or glasses, the connecting portion having end portions, wherein the connecting portion may position the pair of sunglasses or glasses on a user's face when the sunglasses or glasses are in use and when the sunglasses or glasses are not in use, the end portions may be connected to one another with the sunglasses or glasses forming part of a necklace with the connecting portion; and one or more decorative items on the connecting portion.

### BRIEF DESCRIPTION OF THE DRAWINGS

For a more complete understanding of this disclosure, reference is now made to the following description, taken in conjunction with the accompanying drawings, in which:

FIGS. 1A-1B depict a functional jewelry system according to an embodiment of the present disclosure;

FIG. 2 depicts a functional jewelry system according to another embodiment of the present disclosure;

FIG. 3 depicts a functional jewelry system according to another embodiment of the present disclosure;

FIG. 4 depicts a functional jewelry system according to another embodiment of the present disclosure;

FIG. 5 depicts a functional jewelry system according to a further embodiment of the present disclosure; and

FIGS. 6A-6C depict another functional jewelry system according to an embodiment of the present disclosure.

### DETAILED DESCRIPTION

Embodiments of the present disclosure may provide a functional jewelry system that may be presented as armless sunglasses/glasses when they are on a user's face. The functional jewelry system may include chains or other connecting portions extending from each side of the sunglasses/glasses behind, over, and/or around each of the user's ears. The chains/connecting portions may position the sunglasses/glasses on the user's face so that they may stay in place in embodiments of the present disclosure. The chain/connecting portions may be adorned with decorative items in embodiments of the present disclosure. When the user no longer wishes to wear the sunglasses/glasses, they may be removed from the user's face, and end portions of each side of the chain or other connecting portion may be connected to one another through a fastening or attachment mechanism, including, but not limited to, clasps, hooks, loops, and/or magnet closures.

Once fastened or attached, the functional jewelry system may be worn as a necklace with the sunglasses/glasses forming part of the necklace along with the chains/connecting portions. The portion of the necklace formed by the sunglasses/glasses may be positioned at or around the user's neck in an embodiment of the present disclosure so that they are not visible as part of the necklace. However, it should be appreciated that the sunglasses/glasses may be moved around so that they form part of the necklace that may lay on or around the user's chest portion without departing from the present disclosure. While the functional jewelry system has been described as transforming into a necklace when not being worn as sunglasses/glasses, it should be appreciated that other jewelry types may be formed without departing from the present disclosure.

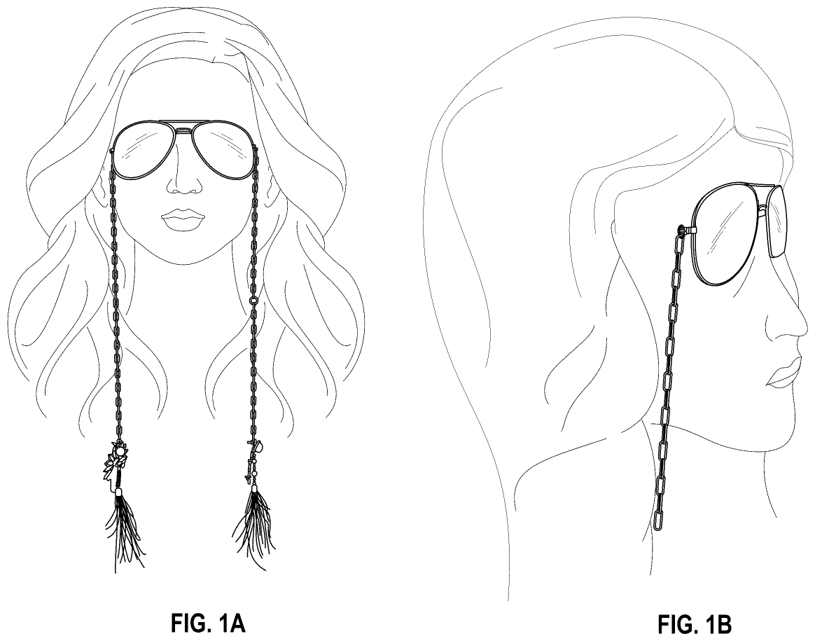

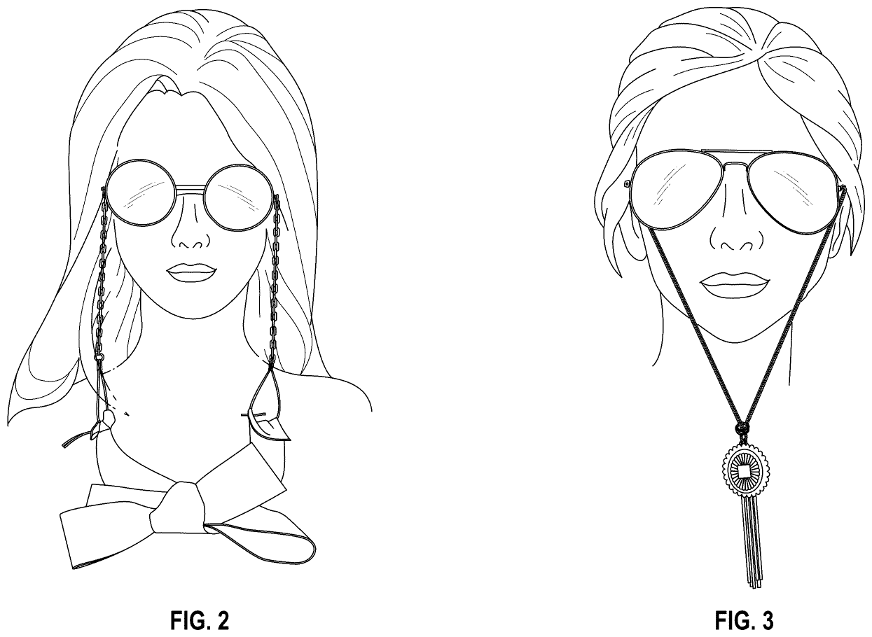

FIGS. 1A-1B depict a functional jewelry system according to an embodiment of the present disclosure. More specifically, FIG. 1A depicts an embodiment where the sunglasses are positioned on a user's eyes (i.e., the sunglasses are being used as sunglasses). FIG. 1B depicts a closer view of a chain that may attach to a side of the sunglasses in an embodiment of the present disclosure. In this embodiment, chains extend from each side of the sunglasses over the user's ears to position and secure the sunglasses relative to the user's face. Whiles chains are depicted in FIGS. 1A-1B, it should be appreciated that connecting portions other than chains may be utilized without departing from the present disclosure. Further, while the chains are depicted as being constructed from metal, other materials may be utilized for the connecting portions without departing from the present disclosure.

The chains may include one or more decorative items including, but not limited to, stones and feathers. However, it should be appreciated that the chains may not include decorative items in some embodiments of the present disclosure. Further, it should be appreciated that there may be embodiments of the present disclosure where only one decorative item extends from the each of the chains. In addition to, or in place of, the one or more decorative items, each of the chains may include a fastening or attachment mechanism to secure each of the chains to one another when the sunglasses are not in use, thereby transforming the sunglasses and chains into a necklace.

FIG. 2 depicts a functional jewelry system according to another embodiment of the present disclosure. Similar to FIGS. 1A-1B, sunglasses may have chains extending from each side; however, in this embodiment, the chains may be attached to one another opposite the sunglasses through a ribbon or bow. As depicted herein, the ribbon or bow may be formed of a cloth material; however, other materials may be utilized without departing from the present disclosure.

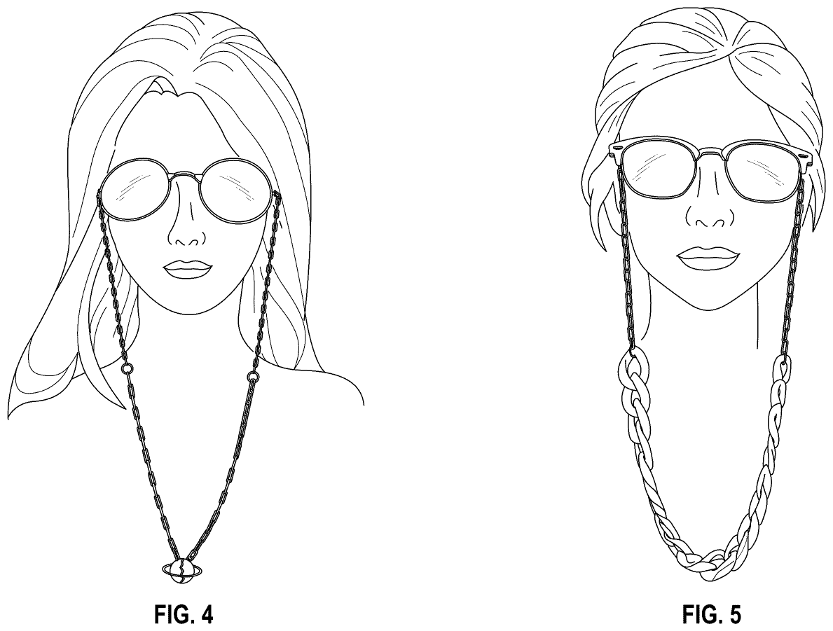

FIG. 3 depicts a functional jewelry system according to another embodiment of the present disclosure. Again, like FIGS. 1A-1B, sunglasses may have chains extending from each side; however, in this embodiment, the chains may be attached to one another with a decorative item, such as a pendant. A similar functional jewelry system is depicted in FIG. 4 substituting a different pendant as the decorative item attaching the chains to one another.

FIG. 5 depicts a functional jewelry system according to a further embodiment of the present disclosure. This embodiment depicts a necklace portion attached to the chains that may be positioned on each side of the sunglasses. The necklace portion may be formed of different materials and may include a fastening or attachment portion so that the necklace portion may be separable into two sides similar to the chains. However, there may be other embodiments of the present disclosure where the necklace portion is formed as a unitary piece (i.e., without a fastening or attachment mechanism).

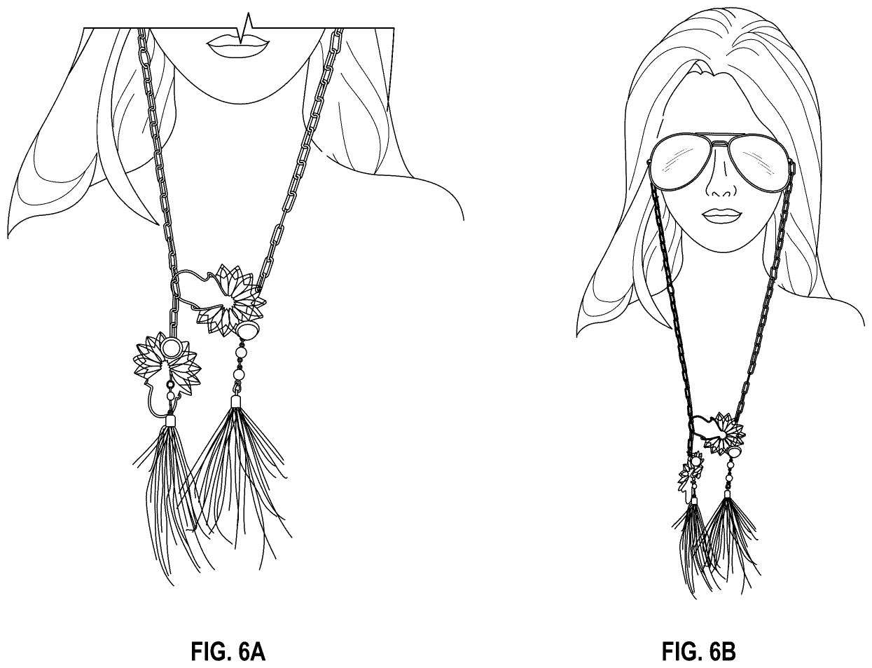

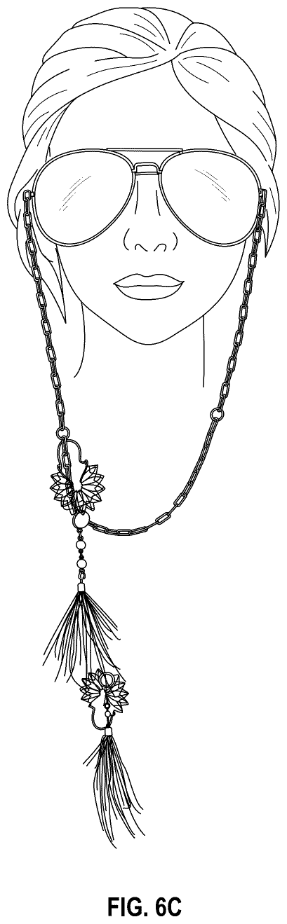

FIGS. 6A-6C depict another functional jewelry system according to an embodiment of the present disclosure. Referring back to FIG. 1A, each of the chain or connector portions may include one or more decorative items. FIG. 6A depicts a close-up view of how the one or more decorative items may provide a fastening or attachment mechanism to secure the chain or connector portions to one another. More specifically, as depicted in FIG. 6A, a decorative item may clasp or otherwise attach/fasten to the chain or connector portion. However, it should be appreciated that the decorative items on each of the chain or connector portions may attach to one another in other embodiments of the present disclosure. There may be other embodiments of the present disclosure where attachment/fastening mechanisms (i.e., no decorative items) may be present on the end portions of the chain or connector portions, and the attachment/fastening mechanisms may connect to one another, or one attachment/fastening mechanism may attach/fasten to a chain or connector portion. FIG. 6B depicts a view of the functional jewelry system once the decorative item is attached/fastened to the other side via the chain or connector portion. In this embodiment, only one of the decorative items has been used to attach/fasten the chain/connector portions to each other, and other decorative items may extend below where the chain/connector portions are attached/fastened to one another. However, there may be other embodiments of the present disclosure where no other decorative items may be present within the functional jewelry system. FIG. 6C depicts another means by which the chain/connector portions may be attached/fastened to each other. As depicted herein, the decorative item or fastening/attachment mechanism from one of the chain/connector portions may be secured at a higher point on the other chain/connector portion. In this embodiment, the decorative items may form a different design, namely, they may be formed as a long pendant. Accordingly, it should be appreciated that having a chain/connector portion with holes or openings along the length to receive the attachment/fastening mechanism at different points on the length may allow for different designs of a necklace in embodiments of the present disclosure. There also may be embodiments of the present disclosure where the earpieces may be looped around each other to form functional jewelry.

It should be appreciated that there may be embodiments of the present disclosure where the decorative items/sunglass attachments may be provided as a unitary system with the sunglasses. However, there also may be embodiments of the present disclosure where the decorative items/sunglass attachments may be provided separately, thereby allowing a user to customize his/her existing sunglasses with functional jewelry pieces.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A functional jewelry system configured to function with a pair of sunglasses or glasses, the functional jewelry system comprising:
a connecting portion that extends from each side of the pair of sunglasses or glasses, the connecting portion having end portions, wherein the connecting portion positions the pair of sunglasses or glasses on a user's face when the sunglasses or glasses are in use and when the sunglasses or glasses are not in use, the end portions are connected to one another through an attachment mechanism with the sunglasses or glasses forming part of a necklace with the connecting portion; and
one or more decorative items on the connecting portion.

2. The functional jewelry system of claim 1, wherein the connecting portion is a chain.

3. The functional jewelry system of claim 1, wherein the connecting portion extends behind, over, and/or around each of a user's ears.

4. The functional jewelry system of claim 1, wherein the attachment mechanism is selected from one or more of the following:
clasps, hooks, loops, and/or magnet closures.

5. The functional jewelry system of claim 1, wherein the part of the necklace formed by the sunglasses or glasses is positionable so that the sunglasses or glasses are not visible as part of the necklace.

6. The functional jewelry system of claim 1, wherein the part of the necklace formed by the sunglasses or glasses are capable of laying on or around a user's chest portion.

7. The functional jewelry system of claim 1, wherein the one or more decorative items are stones and feathers.

8. The functional jewelry system of claim 1, wherein only one decorative item extends from the connecting portion.

9. The functional jewelry system of claim 1, wherein the connecting portion comprises chains extending from each side of the sunglasses or glasses and the chains attached to one another through a ribbon or bow.

10. The functional jewelry system of claim 9, wherein the ribbon or bow is formed of a cloth material.

11. The functional jewelry system of claim 1, wherein the connecting portion comprises chains extending from each side of the sunglasses or glasses and the chains attached to one another through a decorative item.

12. The functional jewelry system of claim 1, wherein the decorative item is a pendant.

13. The functional jewelry system of claim 1, wherein the one or more decorative items are clasped to the connecting portion.

14. The functional jewelry system of claim 1, wherein the one or more decorative items are attachable to one another.

15. The functional jewelry system of claim 1, wherein the connecting portion has one or more holes or openings along a length of the connecting portion to receive the attachment mechanism.

16. The functional jewelry system of claim 1, wherein the functional jewelry system is a unitary system.

17. The functional jewelry system of claim 1, wherein the one or more decorative items, the sunglasses or glasses, and the connecting portion are separate items.

18. A functional jewelry system configured to function with a pair of sunglasses or glasses, the functional jewelry system comprising:
a connecting portion that extends from each side of the pair of sunglasses or glasses, the connecting portion having end portions, wherein the connecting portion positions the pair of sunglasses or glasses on a user's face when the sunglasses or glasses are in use and when the sunglasses or glasses are not in use, the end portions are connected to one another through an attachment mechanism with the sunglasses or glasses forming part of a jewelry item with the connecting portion; and
one or more decorative items on the connecting portion.

19. A functional jewelry system configured to function with a pair of sunglasses or glasses, the functional jewelry system comprising:
a connecting portion that extends from each side of the pair of sunglasses or glasses, the connecting portion having end portions, wherein the connecting portion positions the pair of sunglasses or glasses on a user's face when the sunglasses or glasses are in use and when the sunglasses or glasses are not in use, the end portions are connected to one another with the sunglasses or glasses forming part of a necklace with the connecting portion; and
one or more decorative items on the connecting portion.
